(19) United States
(12) Patent Application Publication
(10) Pub. No.: US 2005/0152768 A1
(43) Pub. Date: Jul. 14, 2005

(54) Fixing plug

(75) Inventor: Paul S. Hepworth, Surrey (GB)

Correspondence Address: NIKOLAI & MERSEREAU, P.A., 900 SECOND AVENUE SOUTH, SUITE 820, MINNEAPOLIS, MN, 55402, US

(73) Assignee: Turner Intellectual Property Limited, Staffordshire (GB)

(21) Appl. No.: 10/648,728

(22) Filed: Aug. 19, 2003

Related U.S. Application Data
(63) Continuation of application No. PCT/GB02/00736, filed on Feb. 20, 2002.

(30) Foreign Application Priority Data
Feb. 20, 2001 (GB) 0104144.1

(51) Int. Cl. F16B 1/00

(52) U.S. Cl. 411/82.5

(57) ABSTRACT

An elongate fixing plug (10) for axially receiving a fixing to enable said fixing to be anchored within a bore formed in a support structure, the plug (10) including a main body (12) defining a structural framework for the plug, the main body including recesses and/or cavities containing a friction generating material (30) capable of frictionally engaging with the wall of said bore.

The present invention relates to a fixing plug, in particular but not exclusively, a screw fixing wall plug.

Fixing plugs are commonly used for enabling a screw fixing to be anchored into a support structure such as a wall. Usually a bore is drilled into the wall and a fixing plug is then inserted into the bore. A screw fixing may then be screwed into the plug and in so doing causes the plug to interengage with the bore wall and so resist axial withdrawal of both the screw fixing and plug.

A general aim of the present invention is to provide a fixing plug which has improved performance characteristics.

According to a first aspect of the present invention there is provided an elongate fixing plug for axially receiving a fixing to enable said fixing to be anchored within a bore formed in a support structure, the plug including a main body defining a structural framework for the plug, the main body including recesses and/or cavities containing a friction generating material capable of frictionally engaging with the wall of said bore.

Preferably the main body is an injection moulding moulded from a suitable rigid but flexible thermoplastic material such as polypropylene.

Preferably the friction generating material is a resiliently deformable mouldable elastomer such as polyurethane. Preferably the friction generating material is integrally moulded with the main body.

Preferably the plug of the present invention is formed by first injection moulding the main body in a first mould, locating the moulded main body in a second mould and injection moulding the frictional material so as to fill selected recesses and/or cavities and, if desired, form predefined surface formations on the surface of said main body.

Various aspects of the present invention are hereinafter described with reference to the accompanying drawings, in which:—

FIG. 1 is a longitudinal sectional view of the main body of a first embodiment of the present invention;

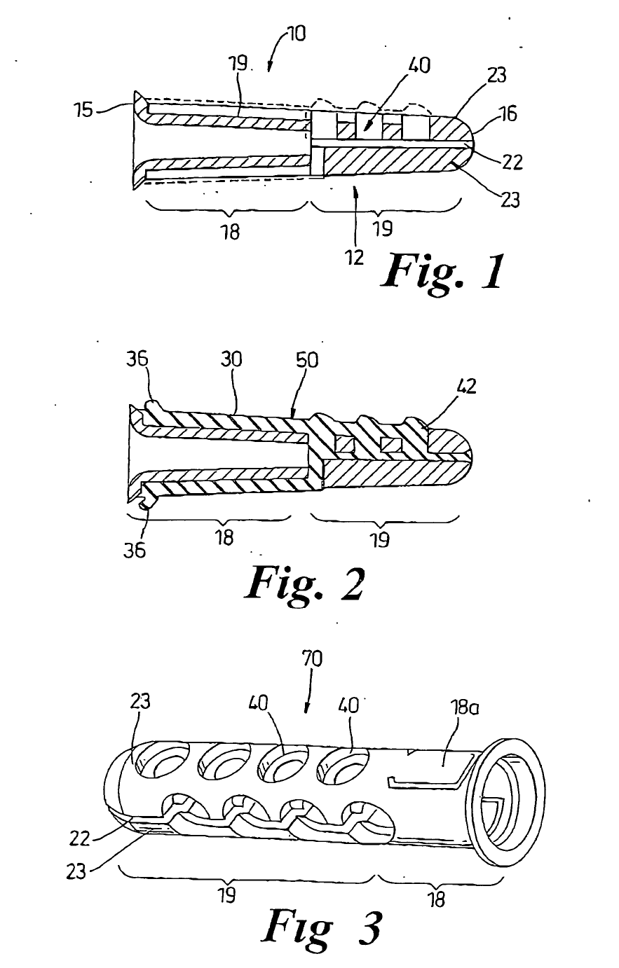

FIG. 2 is a longitudinal section of the main body shown in FIG. 1 after introduction of a second component;

FIG. 3 is a perspective view of the main body of a second embodiment of the present invention; and

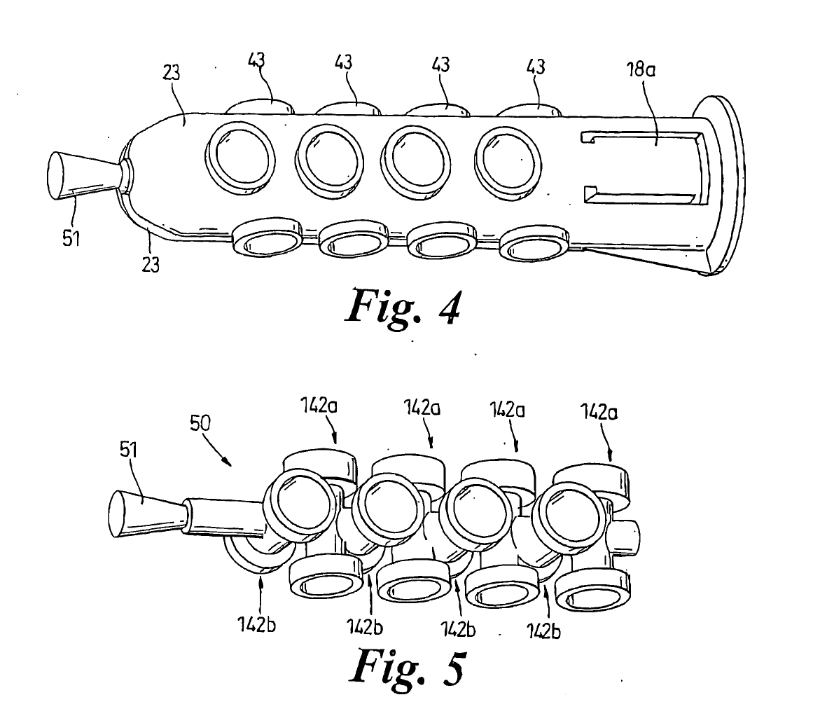

FIG. 4 is a perspective view of the main body shown in FIG. 3 alter introduction of a second component.

Referring initially to FIG. 2 there is shown a fixing plug 10 according to a first embodiment of the present invention.

The fixing plug 10 includes a main body 12 which defines a structural framework for the plug. The main body is formed of a relatively rigid plastics material so as to provide the fixing plug 10 with sufficient structural rigidity and integrity. The plastics material also needs to be sufficiently flexible and deformable in order to enable a screw fixing to be embedded therein. Preferably the rigid plastics material is a thermoplastics such as polypropylene.

The main body 12 is preferably an injection moulding and predominantly defines the overall shape of the fixing plug 10. In particular, the main body 12 includes a first and second body position 18, 19; the first body portion 18 extending from the front end 15 of the plug 10 toward its rear end 16; the second body portion 19 extending from the first body portion 18 to the rear end 16.

Preferably the first body portion 18 is in the form of a continuously walled sleeve 19 having an internal, axially extending bore 14.

The second body portion 19 is preferably in the form of a solid elongate bar which is split longitudinally by one or more slits 22 to define anchorage fingers 23; the slits 22 being centrally located and communicating with the bore 14.

The length and diameter of the bore 14 is preferably chosen such that an externally threaded screw can be partially axially inserted into the bore and when rotated is able to bite into the wall of the body portion 18 surrounding the bore 14. Continued rotation of the screw enables the screw to the forced into the slits 22 and so cause the anchorage fingers 23 to be moved radially outwardly. Preferably as shown, the bore 14 is tapered slightly so as to have a relatively wide diameter located at the front end 15 of the plug 10 and a relatively narrow diameter located adjacent to he second body portion 19.

The main body 12 is provided, preferably at least on its outer surface, with a series of cavities and/or recesses which are preferably filled with a frictional material 30, i.e. a material which has a higher co-efficient of surface friction than the material from which the main body 12 is formed.

Preferably the frictional material 30 is a mouldable material such as an elastomer and is preferably injection moulded into the main body 12 to fill selected cavities and/or recesses and, if desired, to produce predefined surface formations on the main body 12. Preferably the cavities and/or recesses communicate with one another to define an internal mould for the frictional material such that after moulding the frictional material in effect defines an integral core body 50 which is physically interlocked within the main body 12. The frictional material 30 is thereby bonded with the main body 12 and defines an integrally moulded plug 10 formed of two components, viz. the main body 12 defining one component and the frictional material core body 50 defining the other component. A suitable elastomer is polyurethane.

Preferably the frictional material 30 is located on the surface of the plug 10 so as to provide frictional engagement with the bore (not shown) into which the plug 10 is initially inserted. This provides an improved resistance to undesired rotation of the plug 10 when the screw fixing is initially inserted into the plug 10 and rotated.

This may be achieved by moulding the elastomeric material so as to make the plug 10 slightly oversize and/or moulding the elastomeric material so as to create deformable ribs 36 which project from the surface of the plug 10. Preferably the ribs 36 are annular and are located on the first body portion 18 neat to the front end 15.

In the first embodiment, the first body portion 18 is preferably provided with recesses in the form of elongate channels 60 and the second body portion 19 is provided with cavities 40.

Preferably the frictional material 30 is located on the surface of the plug 10, in particular on the second body portion 19, in order to provide improved frictional engagement with the bore (into which the plug is inserted) after the screw fixing has been fully inserted into the plug 10 and causes the anchorage fingers 23 to move radially outwardly. In such a circumstance, the frictional material is highly compressed in the radial direction by engagement with the wall surrounding the bore in which the plug 10 is secured.

In this connection, the second body portion 19 is preferably provided with recesses 40 which are each filled with a body 42 of frictional material, the body 42 preferably including a projection 43 which projects beyond the outer surface of the second body portion 19. Accordingly, after full insertion of the screw fixing, each projection 43 contacts the surrounding wall of the bore and is deformed thereby and places each associated body 43 under resilient compression.

A second embodiment 70 is illustrated in FIGS. 3 to 5 in which parts switch to those in the first embodiment have been designated using the same is reference numerals.

In the second embodiment 70, the first body portion 18 is not provided with frictional material 30. Instead the first body portion 18 is optionally provided with integral flaps 18a which deflect, radially outwardly when a screw fixing is initially inserted into the plug 70 to thereby resist rotation of the plug 70.

Preferably as shown, a series of cavities 40 are provided which are arranged in rows extending along the length of the second body portion 19. The cavities 40 are arranged in diameter pairs which are spaced along the body portion 19 to alternate with intermediate pairs which are off-set by 90°.

After moulding the frictional material 30, the core body 50 is formed by the cavities 40 so as to have diametric pairs of bodies 142a off-set by 90° to diametric pairs of bodies 142b. Preferably projections 43 are dome shaped as shown.

In FIGS. 4 and 5, a spree 51 is shown which is subsequently removed.

It will be appreciated that recesses on the surface of the main body 12 may be shaped to define indicia and/or graphic designs, e.g. logo's, such that after moulding with the frictional material 30 (of say a contrasting colour) the indicia and/or graphic design becomes readily visible.

In the above embodiments the frictional material 30 is arranged such that when the main body 12 is deformed radially outwardly, the frictional material 30 engages the wall of the bore into which the plug is fitted and is deformed and placed under radial compression.

It is envisaged that the main body 12 may be designed so as to include at least the axially spaced body portions having a body of frictional material located therebetween. On introduction of a screw fixing the two axially spaced body portions are caused to move axially together thereby axially compressing the body of frictional material therebetween and causing it to deform radially outwardly.

1. An elongate fixing plug for axially receiving a screw fixing to enable said fixing to be anchored within a bore formed in a support structure and having a wall, the plug including a main body defining a structural framework for the plug, the main body including recesses and/or cavities containing a friction generating material capable of frictionally engaging with the wall of said bore and being formed of a plastics material into which the screw fixing can be embedded.

2. A fixing plug according to claim 1 wherein the main body is an injection moulding moulded from a suitable rigid but flexible thermoplastic material.

3. A fixing plug according to claim 2 wherein said rigid but flexible thermoplastic material is polypropylene.

4. A fixing plug according to any one of claims 1-3 wherein said friction generating material is a resiliently deformable mouldable elastomer.

5. A fixing plug according to claim 4 wherein said elastomer is polyurethane.

6. A fixing plug according to claim 4 wherein said friction generating material is integrally moulded with the main body.

7. A fixing plug according to any one of claims 1-3 wherein the main body includes a first and second body portion, the first portion extending from a front end of the plug toward the rear end and the second portion extending from the first portion to the rear end of the plug, the first body portion being in the form of a continuously walled sleeve having an axially extending bore and the second body portion being in the form of a solid elongate bar which is split longitudinally by one or more slits formed in the main body to define anchorage fingers.

8. A fixing plug according to claim 5 wherein said friction generating material is integrally moulded with the main body.

9. A fixing plug according to claim 4 wherein the main body includes a first and second body portion, the first portion extending from a front end of the plug toward the rear end and the second portion extending from the first portion to the rear end of the plug, the first body portion being in the form of a continuously walled sleeve having an axially extending bore and the second body portion being in the form of a solid elongate bar which is split longitudinally by one or more slits formed in the main body to define anchorage fingers.

10. A fixing plug according to claim 5 wherein the main body includes a first and second body portion, the first portion extending from a front end of the plug toward the rear end and the second portion extending from the first portion to the rear end of the plug, the first body portion being in the form of a continuously walled sleeve having an axially extending bore and the second body portion being in the form of a solid elongate bar which is split longitudinally by one or more slits formed in the main body to define anchorage fingers.

11. A fixing plug according to claim 6 wherein the main body includes a first and second body portion, the first portion extending from a front end of the plug toward the rear end and the second portion extending from the first portion to the rear end of the plug, the first body portion being in the form of a continuously walled sleeve having an axially extending bore and the second body portion being in the form of a solid elongate bar which is split longitudinally by one or more slits formed in the main body to define anchorage fingers.

12. A fixing plug according to claim 8 wherein the main body includes a first and second body portion, the first portion extending from a front end of the plug toward the rear end and the second portion extending from the first portion to the rear end of the plug, the first body portion being in the form of a continuously walled sleeve having an axially extending bore and the second body portion being in the form of a solid elongate bar which is split longitudinally by one or more slits formed in the main body to define anchorage fingers.
